(19) United States
(12) Patent Application Publication
(10) Pub. No.: US 2007/0196661 A1
(43) Pub. Date: Aug. 23, 2007

(54) METHODS FOR REDUCING THE TIME TO PRODUCE A MAR AND/OR SCRATCH RESISTANT COATING ON A SUBSTRATE

(75) Inventors: Michael A. Mayo, Pittsburgh, PA (US); Cynthia Kutchko, Pittsburgh, PA (US); Shengkui Hu, Baden, PA (US)

Correspondence Address: PPG INDUSTRIES INC;INTELLECTUAL PROPERTY DEPT, ONE PPG PLACE, PITTSBURGH, PA, 15272, US

(73) Assignee: PPG INDUSTRIES OHIO, INC., Cleveland, OH (US)

(21) Appl. No.: 11/461,856

(22) Filed: Aug. 2, 2006

Related U.S. Application Data
(60) Provisional application No. 60/748,866, filed on Dec. 9, 2005.

(51) Int. Cl. B32B 27/00; B32B 27/18; B05D 1/12; B05D 3/02

(52) U.S. Cl. 428/411.1; 427/384; 427/180

(57) ABSTRACT

Disclosed are methods for reducing the time required to produce a mar and/or scratch resistant coating on a substrate. The methods comprise (a) applying a coating composition to the substrate, then (b) partially crosslinking crosslinkable components in the composition, and then (c) allowing the coating composition to post cure, wherein, between steps (b) and (c), and after step (c), a mar and/or scratch resistant coating is present on the substrate. Also disclosed are substrates, such as plastic substrates, at least partially coated with a coating produced by such methods as well as related articles of manufacture.

### CROSS-REFERENCE TO RELATED APPLICATIONS

This application claims the benefit of U.S. Provisional Patent Application Ser. No. 60/748,866, filed Dec. 9, 2005, which is incorporated by reference herein in its entirety.

### FIELD OF THE INVENTION

The present invention is directed to methods for reducing the time required to produce a mar and/or scratch resistant coating on a substrate, such as a plastic substrate. More particularly, the methods of the present invention comprise (a) applying a coating composition to the substrate, then (b) partially crosslinking crosslinkable components in the composition, and then (c) allowing the coating composition to post cure, wherein, between steps (b) and (c), and after step (c), a mar and/or scratch resistant coating is present on the substrate. The present invention is also directed to substrates, such as plastic substrates, at least partially coated with a coating produced by such methods, as well as related articles of manufacture.

### BACKGROUND OF THE INVENTION

Various products, such as, for example, exterior automotive parts and components, are often treated with multiple layers of coatings which not only enhance the appearance of the product, but also protect the product from defects, such as those resulting from corrosion, chipping, ultraviolet light, acid rain and other environmental conditions. One challenge that faces many manufacturers of these products is to identify ways to reduce the time required to deposit a protective coating system.

Many coatings are dried and cured using a thermal bake process, wherein the coated product is passed through an oven set at an elevated temperature. Numerous proposals have been made for accelerating the drying and curing processes for such coatings. Many of these proposals, however, involve rapid, high temperature drying techniques that can be undesirable because these techniques can result in coating defects, such as pops, bubbles or blisters. Moreover, certain materials, such as thermoplastic polyolefin (“TPO”) based products, are sensitive to temperature such that high temperature drying and curing techniques cannot be used. Such materials are commonly used to construct exterior automotive parts and components.

Other coatings may be rapidly dried and cured using radiation cure techniques, such as by exposing the coating to ultraviolet (“UV”) radiation. The implementation of UV radiation, however, can often require a significant capital investment which is often unacceptable.

As a result, it would be desirable to provide a method for reducing the cycle time to produce a mar and/or scratch resistant coating on a substrate, such as a plastic substrate, without utilizing a high temperature drying technique or radiation cure techniques.

### SUMMARY OF THE INVENTION

In certain respects, the present invention is directed to methods for reducing the time required to produce a mar and/or scratch resistant coating on a substrate comprising (a) applying a coating composition to the substrate, then (b) partially crosslinking crosslinkable components in the composition, and then (c) allowing the coating composition to post cure, wherein, between steps (b) and (c), and after step (c), a mar and/or scratch resistant coating is present on the substrate.

The present invention is also directed to substrates, such as plastic substrates, at least partially coated with a coating produced by such methods.

In another respect, the present invention is directed to articles of manufacture having a surface at least partially coated with a mar and/or scratch resistant coating that is a partially crosslinked film.

### DETAILED DESCRIPTION OF THE INVENTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. For example, and without limitation, this application refers to methods that comprise the step of applying “a coating composition” to a substrate. Such references to “a coating composition” are meant to encompass methods wherein a single coating composition is applied to the substrate as well as methods wherein two or more coating compositions are applied. In addition, in this application, the use of “or” means “and/or” unless specifically stated otherwise, even though “and/or” may be explicitly used in certain instances.

As indicated, in certain embodiments, the present invention is directed to methods for reducing the time required to produce a mar and/or scratch resistant coating on a substrate. As will be appreciated by those skilled in the art, the terms “mar” and “scratch” refer to physical deformations resulting from mechanical or chemical abrasion. “Mar resistance” is a measure of a material's ability to resist appearance degradation caused by small scale mechanical stress. “Scratch resistance” is the ability of a material to resist more severe damage that can lead to more visible, deeper or wider trenches. Thus, scratches are generally regarded as being more severe than what is referred to in the art as mar, and the two are regarded in the art as being different. As will be appreciated, mar and scratch can result from manufacturing and environmental factors as well as through normal use. As used herein, the term “mar and/or scratch resistant coating” refers to a coating that retains at least 30 percent of its initial 200 gloss after abrading the coating surface as described below. In certain embodiments, at least 40 percent of the initial 20° gloss is retained and, in yet other cases, at least 60 percent of the initial 20° gloss is retained after abrading the coating surface. The 20° gloss of a cured coated substrate according to the present invention can be measured using a 20° NOVO-GLOSS statistical glossmeter, available from Gardner Instrument Company, Inc. The coated substrate is abraded by subjecting it to ten double rubs with a weighted abrasive paper using an Atlas AATCC Scratch Tester, Model CM-5, available from Atlas Electrical Devices Company of Chicago, Ill. The abrasive paper is 3M 281Q WETORDRY™ PRODUCTION™ 9 micron polishing paper sheets which are commercially available from 3M Company of St. Paul, Minn. Panels are then rinsed with tap water and carefully patted dry with a paper towel. The 20° gloss is measured on the abraded area of the test panel. The number reported is the percent of the initial gloss retained after scratch testing, i.e., 100%×scratched gloss/initial gloss.

As used herein, the term “substrate” refers to any material with a surface that may be coated with a film, including bare substrates as well as substrates that already have a coating deposited thereon. In certain embodiments of the present invention, the substrate comprises a plastic substrate. As used herein, the term “plastic substrate” is intended to include any substrate constructed at least partially from a thermoplastic or thermosetting synthetic material used in injection or reaction molding, sheet molding or other similar processes whereby parts are formed, such as, for example, TPO, acrylonitrile butadiene styrene (“ABS”), polycarbonate, thermoplastic elastomer, polyurethane, and thermoplastic polyurethane, among others.

As indicated, certain methods of the present invention comprise applying a coating composition to the substrate. In certain embodiments, the coating composition is in liquid form, i.e., it is a water-borne or solvent-borne system. Organic solvents that may be used in such coating compositions include, for example, alcohols, ketones, aromatic hydrocarbons, glycol ethers, esters or mixtures thereof. In solvent-based compositions, the solvent is generally present in amounts ranging from 5 to 80 weight percent based on total weight of the composition, such as 30 to 50 weight percent. Even higher weight percents of solvent can be present in water-based compositions and those that comprise water/cosolvent mixtures.

In certain embodiments, the composition comprises a thermosetting film-forming resin. As used herein, the term “thermosetting” refers to resins that “set” irreversibly upon curing or crosslinking, wherein the polymer chains of the polymeric components are joined together by covalent bonds. This property is usually associated with a cross-linking reaction of the composition constituents. See Hawley, Gessner G., The Condensed Chemical Dictionary, Ninth Edition., page 856; Surface Coatings, vol. 2, Oil and Colour Chemists' Association, Australia, TAFE Educational Books (1974). Once cured or crosslinked, a thermosetting resin will not melt upon the application of heat and is insoluble in solvents.

In certain embodiments, the thermosetting film-forming resin comprises (i) a reactive functional group containing polymer, and (ii) a curing agent having functional groups reactive with the reactive functional groups of the polymer. In certain embodiments, the polymer is selected from hydroxyl and/or carboxylic acid-containing acrylic copolymers, hydroxyl and/or carboxylic acid-containing polyester polymers, oligomers and isocyanate and/or hydroxyl-containing polyurethane polymers, amine and/or isocyanate-containing polyureas, or a mixture thereof. These polymers are further described in U.S. Pat. No. 5,939,491, column 7, line 7 to column 8, line 2; this patent, as well as the patents referenced therein, being incorporated by reference herein. Suitable curing agents include, but are not limited to, those described in the '491 patent at column 6, line 6 to line 62. Combinations of curing agents can be used.

In certain embodiments, the film-forming resin is present in the coating compositions in an amount greater than about 20 weight percent, such as greater than about 40 weight percent, and less than 90 weight percent, with weight percent being based on the total solid weight of the composition. For example, the weight percent of resin can be between 20 and 80 weight percent. When a curing agent is used, it is generally present in an amount of up to 50 weight percent; this weight percent is also based on the total solid weight of the coating composition.

In certain embodiments, the coating composition comprises a cure catalyst, i.e., a catalyst to accelerate the reaction of the polymer (i) and the curing agent (ii). Suitable catalysts include, for example, organotin compounds such as dibutyltin oxide, dioctyltin oxide, dibutyltin dilaurate, and the like. Suitable catalysts for other crosslinking agents may used when necessary as known to those skilled in the art. In certain embodiments, the catalyst is present in an amount of 0.01 to 5.0 percent by weight, such as 0.05 to 2.0 percent by weight, based on the total weight of resin solids in the coating composition.

In certain embodiments, the coating composition comprises a plurality of particles dispersed in the film-forming resin. The particles used in the present invention can have an average particle size ranging in the nanometer to microrange. “Nanoparticles” can be used in a size range of between 2.0 and 500 nanometers, such as between about 5 and 200 nm. “Microparticles” can be used in a size range of between about 0.5 and 100 microns, such as greater than 1 micron to 50 microns, 0.5 to 30 microns or 0.5 to 10 microns.

Particle size can be determined according to any method known in the art, such as by a conventional particle size analyzer. For example, where the average particle size is greater than 1 micron, laser scattering techniques can be employed. For example, the average particle size of such particles can be measured using a Horiba Model LA 900 laser diffraction particle size instrument, which uses a helium-neon laser with a wave length of 633 nm to measure the size of the particles and assumes the particle has a spherical shape, i.e., the “particle size” refers to the smallest sphere that will completely enclose the particle. In cases where the average particle size is smaller than 1 micron, the average particle size can be determined by visually examining an electron micrograph of a transmission electron microscopy (“TEM”) image, measuring the diameter of the particles in the image, and calculating the average particle size based on the magnification of the TEM image. One of ordinary skill in the art will understand how to prepare such a TEM image and a description of a suitable method is disclosed in U.S. Pat. No. 6,610,777 at col. 29, line 64 to col. 30, lines 8, the cited portion of which being incorporated by reference herein.

The shape (or morphology) of the particles can vary depending on the type of particle or particles selected. For example, generally spherical particles, such as crystalline materials, solid beads, microbeads, or hollow spheres, can be used, as can particles that are platy, cubic or acicular (that is, elongated or fibrous). The particles can also have a random or nonuniform morphology. In addition, the particles can have an internal structure that is hollow, porous or void free, or any combination, such as a hollow center with porous or solid walls. It will be appreciated that for certain applications, one particle shape may be more suitable than others. Particle shape may be irrelevant, however, for other applications. It will be appreciated that combinations of particles having different morphologies can be used to give the desired characteristics to the final coating.

As will be appreciated, mixtures of two or more particles having different average particle sizes can be incorporated into the compositions in accordance with the present invention to impart the desired properties and characteristics to the compositions. For example, nanosized particles that are particularly suitable for imparting mar resistance and microparticles that are particularly suitable for imparting scratch resistance can be combined.

The particles can be formed from materials selected from polymeric and nonpolymeric inorganic materials, polymeric and nonpolymeric organic materials, composite materials, and mixtures of any of the foregoing. Examples of such materials, which are suitable for use in the present invention, are described in U.S. Pat. No. 6,610,777 at col. 30, line 28 to col. 36, line 31, the cited portion of which being incorporated herein by reference.

In certain embodiments, the particles are chemically modified to have a surface tension lower than that of the film-forming resin as cured without the particles. Examples of such particles, which are suitable for use in the present invention, are described in U.S. Pat. No. 6,790,904 at col. 3, line 43 to col. 8, line 61, the cited portion of which being incorporated herein by reference.

The particles are present in the coating composition in an amount sufficient to produce a mar and/or scratch resistant coating, even when the extent of crosslinking of crosslinkable components in the composition is insufficient to produce a mar and/or scratch resistant coating. In certain embodiments, the particles are present in the coating composition in an amount ranging from 0.01 to 20.0 weight percent, such as from 0.01 to 10 weight percent, or, in some cases, 0.01 to 8 weight percent, where weight percent is based on total solid weight of the coating composition.

Optional ingredients such as, for example, plasticizers, surfactants, thixotropic agents, anti-gassing agents, organic cosolvents, flow controllers, anti-oxidants, UV light absorbers and similar additives conventional in the art may be included in the composition. These ingredients are typically present at up to 40% by weight based on the total weight of resin solids.

The coating composition can be applied to the substrate in any of a variety of ways. For example, such compositions can be applied by any conventional method such as brushing, dipping, flow coating, roll coating, conventional and electrostatic spraying. Spray techniques are most often used. Typically, film thickness for liquid coatings can range between 0.1 and 5 mils, such as between 0.5 and 3 mils, or about 1.5 mils.

As previously indicated, certain methods of the present invention comprise partially crosslinking crosslinkable components in the composition. As used herein, the term “partially crosslinking crosslinkable components in the composition” means that the crosslinkable components in the composition are reacted such that a partially crosslinked coating is formed. As used herein, the term “partially crosslinked coating” refers to coatings in which some, but not all, of the crosslinkable components in the composition have been crosslinked. In certain embodiments of the present invention, the crosslinkable components in the partially crosslinked coating have been crosslinked in an amount to provide a coating with a crosslink density that ranges from 25 to 75 percent, such as 50 to 75 percent, of the maximum crosslink density achieved by the coating (i.e., 100%×crosslink density after partial crosslinking step/maximum crosslink density). One skilled in the art will understand that the presence and degree of crosslinking, i.e., crosslink density, can be determined by a variety of methods, such as dynamic mechanical thermal analysis (DMTA) using a TA Instruments DMA 2980 DMTA analyzer conducted under nitrogen. This method determines the glass transition temperature and crosslink density of free films of coatings or polymers. These physical properties of a cured material are related to the structure of the crosslinked network.

In certain embodiments, the partial crosslinking is accomplished by exposing the coating composition to an abbreviated thermal bake. In such embodiments, the coating composition may comprise a thermally curable composition, such as those using an isocyanate curing agent that is often prepared as a two-package system (“2K”), in which the curing agent is kept separate from the reactive functional group containing polymer. While curable at minimally elevated temperature, the cure of such compositions is often hastened by exposing the composition to elevated temperatures of from, for example, 180° F. to 450° F. (82° C. to 232° C.) with temperature primarily dependent upon the type of substrate used. For example, with certain plastic substrates, such as TPO, a substrate surface temperature in the range of 180° F. to 265° F. (82° C. to 129° C.) is often used.

As indicated, in certain methods of the present invention, an “abbreviated” thermal bake is used. As used herein, the term “thermal bake” is meant to encompass heating of the coated substrate by convection heating, infrared radiation, or a combination thereof. As used herein, the term “abbreviated thermal bake” means that the dwell time (i.e., the time that the coated substrate is exposed to elevated temperature for curing) is sufficient to form a partially crosslinked coating, but not a fully crosslinked coating. Indeed, a surprising discovery of the present invention is that a mar and/or scratch resistant coating can be produced with only a partially crosslinked coating that is produced using an abbreviated thermal bake wherein the dwell time is at least 25% less or, in some cases, at least 50% less or, in yet other cases, at least 75% less than the time required to produce a fully crosslinked film. As used herein, the term “fully crosslinked coating” refers to coatings that have been crosslinked in an amount to provide a coating with a crosslink density that is more than 75 percent, such as at least 90 percent, of the maximum crosslink density achieved by the coating (i.e., 100%×crosslink density after partial crosslinking step/maximum crosslink density). It is believed that such dramatic reduction in cycle time can significantly reduce manufacturing costs.

As will be appreciated by those skilled in the art, the dwell time required to produce a fully crosslinked coating is dependent upon several variables, such as the cure temperature used as well as wet film thickness of the applied coating composition. For example, coated exterior plastic automotive parts often require a longer dwell time at a lower cure temperature (e.g., 20-25 minutes at a substrate surface temperature of at least 180° F. (82° C.)) to produce a fully crosslinked coating. In certain embodiments of the present invention, however, the partial crosslinking is accomplished by heating the coated substrate to a substrate surface temperature of at least 180° F. (82° C.) for no more than 10 minutes, in some cases no more than 6 minutes, such as 2 to 6 minutes. Thus, as previously indicated, when utilizing a method of the present invention, the time required to produce a mar and/or scratch resistant coating on a substrate can be significantly reduced.

In certain embodiments, the methods of the present invention comprise allowing the coating composition to post cure. As used herein, the term “post cure” means that the crosslinkable components in the composition continue crosslinking after completion of the partial crosslinking step until a fully crosslinked coating is achieved. In certain embodiments, the step of allowing the coating composition to post cure merely entails allowing the coated substrate to rest at ambient conditions. As used herein, the term “ambient conditions” refers to ambient pressure (i.e., atmospheric pressure) and ambient temperature (i.e., 68° to 79° F. (20° to 26° C.)).

In certain embodiments, the coating composition described above comprises a clearcoat composition, which is applied to the substrate as part of a multi-component composite coating system comprising a pigmented basecoat composition and a clearcoat composition applied over at least a portion of the basecoat. In these embodiments, prior to application of the coating composition described above, a basecoat composition is applied that comprises a film-forming resin and, often, one or more pigments to act as the colorant.

Particularly useful resin systems for the basecoat composition are acrylic polymers, polyesters, including alkyds, and polyurethanes. The resinous binders for the basecoat can be organic solvent-based materials such as those described in U.S. Pat. No. 4,220,679, note column 2 line 24 continuing through column 4, line 40, which is incorporated herein by reference. Also, water-based coating compositions such as those described in U.S. Pat. No. 4,403,003, U.S. Pat. No. 4,147,679 and U.S. Pat. No. 5,071,904 (incorporated herein by reference) can be used as the binder in the basecoat composition.

The basecoat composition can contain pigments as colorants. Suitable metallic pigments include aluminum flake, copper or bronze flake and metal oxide coated mica. Besides the metallic pigments, the basecoat compositions can contain non-metallic color pigments conventionally used in surface coatings including inorganic pigments such as titanium dioxide, iron oxide, chromium oxide, lead chromate, and carbon black; and organic pigments such as, for example, phthalocyanine blue and phthalocyanine green.

Optional ingredients in the basecoat composition include those which are well known in the art of formulating surface coatings, such as surfactants, flow control agents, thixotropic agents, fillers, anti-gassing agents, organic co-solvents, catalysts, and other customary auxiliaries. Examples of these materials and suitable amounts are described in U.S. Pat. Nos. 4,220,679, 4,403,003, 4,147,769 and 5,071,904, which are incorporated herein by reference.

The basecoat compositions can be applied to the substrate by any conventional coating technique such as brushing, spraying, dipping or flowing, but they are most often applied by spraying. The usual spray techniques and equipment for air spraying, airless spray and electrostatic spraying in either manual or automatic methods can be used.

During application of the basecoat to the substrate, the film thickness of the basecoat formed on the substrate often ranges from 0.1 to 5 mils (2.54 to about 127 micrometers), or 0.1 to 2 mils (about 2.54 to about 50.8 micrometers).

After forming a film of the basecoat on the substrate, the basecoat can be cured or alternately given a drying step in which solvent is driven out of the basecoat film by heating or an air drying period before application of the clear coat. Suitable drying conditions will depend on the particular basecoat composition, and on the ambient humidity if the composition is water-borne, but often, a drying time of from 1 to 15 minutes at a temperature of 75° to 200° F. (21° to 93° C.) will be adequate.

The solids content of the base coating composition often generally ranges from 15 to 60 weight percent, or 20 to 50 weight percent.

In an alternative embodiment, after the basecoat is applied (and cured, if desired), multiple layers of clear topcoats can be applied over the basecoat. This is generally referred to as a “clear-on-clear” application. For example, one or more layers of a conventional transparent coat can be applied over the basecoat and one or more layers of a transparent coating composition of the type described earlier applied thereon. Alternatively, one or more layers of a transparent coating can be applied over the basecoat as an intermediate topcoat, and one or more transparent coatings applied thereover.

As a result, certain methods of the present invention comprise: (a) applying a first coating composition to a substrate, then (b) applying a second coating composition over at least a portion of the first coating composition, wherein the second coating composition comprises a film-forming resin, a cure catalyst, and a plurality of particles dispersed in the film-forming resin, (c) partially crosslinking crosslinkable components in the second coating composition, and then (d) allowing the second coating composition to post cure. In the methods of the present invention, between steps (c) and (d), and after step (d), the second coating composition is present in the form of a mar and/or scratch resistant coating.

As should be appreciated from the foregoing description, the present invention is also directed to substrates, including plastic substrates, such as TPO substrates, at least partially coated with a coating produced by a method of the present invention.

In addition, as should also be appreciated from the foregoing description, the present invention is also directed to articles of manufacture having a surface at least partially coated with a mar and/or scratch resistant coating that is a partially crosslinked film. In certain embodiments, the article of manufacture comprises an automotive part or component, such as an exterior automotive part or component, such as a bumper, fascia, mirror housing, door handle, fender flare, cladding, spoiler, gas cap cover, and the like.

Illustrating the invention are the following examples that are not to be considered as limiting the invention to their details. All parts and percentages in the examples, as well as throughout the specification, are by weight unless otherwise indicated.

### EXAMPLES

### Example 1

A clear film-forming composition was prepared by mixing together the following ingredients under agitation in the order in which they appear:

| | Sample | | | |
|---|---|---|---|---|
| Ingredients | A | Sample B | Sample C | Sample D |
| Ethyl 3-ethoxy propionate | 19.6 | 19.6 | 19.6 | 19.6 |
| n-butyl propionate | 7.2 | 7.2 | 7.2 | 7.2 |
| Acetone | 20.0 | 20.0 | 20.0 | 20.0 |
| Tinuvin 328¹ | 3.0 | 3.0 | 3.0 | 3.0 |
| Silica dispersion² | 8.6 | 8.6 | — | — |
| Acrylic Polyol³ | 68.6 | 68.6 | 75.1 | 75.1 |
| Polyester Polyol⁴ | 11.6 | 11.6 | 11.6 | 11.6 |
| Tinuvin 123⁵ | 1.1 | 1.1 | 1.1 | 1.1 |
| Silica dispersion⁶ | 22.1 | 22.1 | 22.1 | 22.1 |
| BYK 306⁷ | 0.14 | 0.14 | 0.14 | 0.14 |
| BYK 310⁸ | 0.28 | 0.28 | 0.28 | 0.28 |
| Dibutyl tin dilaurate | 0.08 | — | — | 0.08 |

The following two ingredients were added to the above mixture
immediately prior to application of the coating:

| n-butyl propionate | 15.2 | 15.2 | 15.2 | 15.2 |
|---|---|---|---|---|
| DESMODUR N-3300⁹ | 38.6 | 38.6 | 37.5 | 37.5 |
| ¹UV absorber available from Ciba Additives. | | | | |
| ²A total of 225 parts of Dowanol PM ® (Propylene glycol methyl ether, available from Dow Chemical Co.) was added slowly at room temperature to 1482 parts of a 20% solution of colloidal silica in water available from Nissan Chemical as SNOWTEX O ®. The mixture was heated to 50° C. in a suitable reactor equipped with temperature probe, addition funnel and vacuum distillation apparatus. When the mixture reached 50° C., the pressure in the | | | | |
| # reactor was reduced about 60 to 100 mmHg to effect distillation, while an additional 1442 parts of DOWANOL PM ® was added slowly to the reaction mixture. A total of 2162 parts of distillate was removed, bringing the contents of the reactor to about 30% solids. 4.9 parts of poly(butyl acrylate) were then added to the reaction mixture. 395 parts of the tetraol-functional siloxane (as described in patent U.S. Pat. No. 6387519) were mixed with 296 parts of n-propyl | | | | |
| # alcohol and this mixture was then added to the contents of the reactor over about a 1 hour period. A total of about 460 parts of solvent were then removed by vacuum distillation. Finally, 343 parts of methyl amyl ketone were added to the reactor contents over about a 15 minute period and 343 parts of distillate were subsequently removed from the reaction mixture by vacuum distillation. The final reaction mixture was allowed to cool slightly, and then poured into a suitable | | | | |
| # container. The final product was a slightly hazy solution that was found to have a measured solids of 58% and to have a Gardner-Holt viscosity of < A. | | | | |

³Acrylic polyol: 34.8% hydroxy ethyl methacrylate/23.4% 2-ethylhexyl methacrylate/20.8% 2-ethylhexyl acrylate/20% styrene/1% methacrylic acid - 60% solids in n-butyl acetate and methyl ether propylene glycol acetate with a Mw around 6700.
⁴Polyester polyol: 23% 1,6 hexane diol/18.6% trimethylol propane/8.3% trimethyl pentane diol/18.5% adipic acid/31.8% 4-methyl hexahydrophthalic anhydride - 80% solids in n-butyl acetate with an Mw around 5000.
⁵Hindered amine light stabilizer available from Ciba Additives.
⁶Dispersion of R812 fumed silica (available from Degussa) in an acrylic polyol (40% hydroxy propyl acrylate/20% styrene/19% n-butyl acrylate/18.5% n-butyl methacrylate/2% acrylic acid/0.5% methylmethacrylate with a Mw around 7000); with the dispersion containing 7.7% silica, 33.5% acrylic polyol, 58.8% solvent.
⁷Flow additive available from BYK-Chemie.
⁸Flow additive available from BYK-Chemie.
⁹Polyisocyanate available from Bayer.

Sample E was a commercially available two-component urethane clearcoat (TKU2000, available from PPG Industries, Inc.).

Sample A and Sample E were spray applied onto Sequel 1440 TPO (thermoplastic polyolefin) plaques (available from Custom Precision) to achieve a dry film thickness between 1.5 to 1.7 mils. The clearcoated plaques sat at ambient temperature for 10 minutes before baking in a convection oven set at 250° F. for the time specified in Table 1. After cooling to room temperature, the clearcoats were removed from the TPO plaques as continuous free-films for measurement of Tg (glass transition temperature) and crosslink density. The results for initial (same day) and post-cured (7 days) free films are shown in Table 1. Tg and crosslink density (10³ moles/cc) were measured on the free films using a TA Instruments model 2980 DMTA in tensile film mode with an amplitude of 20 microns, frequency of 1 Hz, temperature cycle of −50 to 150° C., a rate of 3° C./minute, and sample size of 15×6.5 mm×film thickness.

Additionally, MPP4100D (adhesion promoter commercially available from PPG Industries, Inc.) was spray applied to Sequel 1440 plaques to achieve a dry film thickness of 0.2 to 0.4 mils. After allowing the adhesion promoted panels to sit at ambient conditions for 10 minutes, a two-component solventbome black basecoat commercially available from PPG Industries, Inc. (TKPS8555) was spray applied onto the MPP4100D coated panels to achieve a dry film thickness of 0.9 to 1.1 mils. After allowing the basecoated panels to sit at ambient conditions for 4 minutes, Samples A-E were spray applied onto the basecoated panels to achieve a dry film thickness of 1.5-2.0 mils. After allowing the clearcoated panels to sit for 10 minutes at ambient temperature, the panels were baked in a convection oven set at 250° F. for 10 minutes. The test panels were then subjected to mar resistance testing as described earlier. The mar resistance results are shown in Tables 1 and 2.

TABLE 1

| | | Initial Properties | | | | Post-Cure Properties | | | |
|---|---|---|---|---|---|---|---|---|---|
| | | (Same day as bake) | | | | (7 days after bake) | | | |
| | | Initial | | | | Initial | | | |
| | Coating | 20° | Mar Gloss | Tg | Crosslink | 20° | Mar Gloss | Tg | Crosslink |
| | Bake | Gloss | Retention | (° C.) | Density | Gloss | Retention | (° C.) | Density |
| Sample A | 10′/250° F. | 87 | 82 | 35 | 0.66 | 87 | 70 | 64 | 2.29 |
| Sample E | 40′/250° F. | 88 | 23 | 63 | 2.39 | 88 | 23 | 72 | 2.07 |

TABLE 2

| | | | | | | 13 Day |
|---|---|---|---|---|---|---|
| | | | | | Initial Mar | Post-Cure |
| | Inorganic | | Coating | | Gloss | Mar Gloss |
| | Particles | Catalyst | Bake | Initial Gloss | Retention | Retention |
| Sample A | Yes | Yes | 10′/250° F. | 87 | 82 | 70 |
| Sample B | Yes | None | 10′/250° F. | 87 | 75 | 61 |
| Sample C | None | None | 10′/250° F. | 88 | 56 | 22 |
| Sample D | None | Yes | 10′/250° F. | 86 | 27 | 26 |

In Table 1, note that after only a 10 minute bake at 250° F., Sample A of the present invention has excellent mar resistance both initially and after 7 day post-curing; demonstrating excellent mar resistance initially, even though it was not near to being fully cured as indicated by the Tg and crosslink density measurements initially vs. post-cure aging. By comparison, after a 40 minute bake at 250° F., the commercially available Sample E had significantly worse initial and post-cured mar resistance even though it was nearly fully cured as indicated by the Tg and crosslink density measurements initially vs. post-cure aging.

In Table 2, note that with the short bake of 10 minutes at 250° F., Sample A (containing both inorganic particles and catalyst) has good mar resistance both initially and after 7 day post curing. Sample B (containing particles, but no catalyst) has good mar resistance, but slightly worse than Sample A containing both particles and catalyst. Sample C (containing no particles and no catalyst) has considerably worse initial and post-cured mar resistance than both Sample A and Sample B. Sample D (containing catalyst, but no particles) has significantly worse initial and post-cured mar resistance compared to Sample A.

It will be readily appreciated by those skilled in the art that modifications may be made to the invention without departing from the concepts disclosed in the foregoing description. Such modifications are to be considered as included within the following claims unless the claims, by their language, expressly state otherwise. Accordingly, the particular embodiments described in detail herein are illustrative only and are not limiting to the scope of the invention which is to be given the full breadth of the appended claims and any and all equivalents thereof.

We claim:

1. A method for reducing the time required to produce a mar and/or scratch resistant coating on a substrate comprising:
(a) applying a coating composition to the substrate, then
(b) partially crosslinking crosslinkable components in the composition, and then
(c) allowing the coating composition to post cure,
wherein, between steps (b) and (c), and after step (c), a mar and/or scratch resistant coating is present on the substrate.

2. The method of claim 1, wherein the substrate comprises a plastic substrate.

3. The method of claim 2, wherein the plastic substrate comprises thermoplastic polyolefin.

4. The method of claim 1, wherein the coating composition comprises a film-forming resin, a cure catalyst, and a plurality of particles dispersed in the film-forming resin.

5. The method of claim 4, wherein the film-forming resin comprises (i) a reactive functional group containing polymer, and (ii) a curing agent having functional groups reactive with the reactive functional groups of the polymer.

6. The method of claim 5, wherein the reactive functional group containing polymer comprises a hydroxyl-containing acrylic copolymer and/or a hydroxyl-containing polyester polymer.

7. The method of claim 4, wherein the particles are formed from materials selected from polymeric and nonpolymeric inorganic materials, polymeric and nonpolymeric organic materials, composite materials, or a mixture thereof.

8. The method of claim 4, wherein the particles are chemically modified to have a surface tension lower than that of the film-forming resin as cured without the particles.

9. The method of claim 8, wherein the particles are modified by attachment of a compound having the structure:
F-L-Z
wherein F is a moiety comprising a functional group; Z is a moiety that decreases the surface tension of the particle to which it is attached; and L is a group that links F and Z.

10. The method of claim 4, wherein the particles are present in the coating composition in an amount sufficient to produce a mar and/or scratch resistant coating, when the composition is in the form of a partially crosslinked coating.

11. The method of claim 10, wherein the particles are present in the coating composition in an amount ranging from 0.01 to 20 weight percent, based on the total solid weight of the coating composition.

12. The method of claim 6, wherein the step of partially crosslinking crosslinkable components in the composition is accomplished by exposing the coating composition to an abbreviated thermal bake.

13. The method of claim 12, wherein the abbreviated thermal bake has a dwell time at least 25% less than the dwell time required to produce a fully crosslinked coating.

14. The method of claim 13, wherein the abbreviated thermal bake comprises heating the coated substrate to a substrate surface temperature of at least 180° F. for no more than 10 minutes.

15. The method of claim 14, wherein the abbreviated thermal bake comprises heating the coated substrate to a substrate surface temperature of at least 180° F. for 2 to 6 minutes.

16. The method of claim 1, wherein the step of allowing the coating composition to post cure comprises allowing the coated substrate to rest at ambient conditions.

17. A substrate at least partially coated with a coating produced by the method of claim 1.

18. A method for reducing the time required to produce a mar and/or scratch resistant coating on a substrate comprising:
(a) applying a coating composition to the substrate, wherein the coating composition comprises a film-forming resin, a cure catalyst, and a plurality of particles dispersed in the film-forming resin, then
(b) partially crosslinking crosslinkable components in the composition, and then
(c) allowing the coating composition to post cure,
wherein, between steps (b) and (c), and after step (c), a mar and/or scratch resistant coating is present on the substrate.

19. An article of manufacture having a surface at least partially coated with a mar and/or scratch resistant coating that is a partially crosslinked film.
